(19) United States
(12) Patent Application Publication
(10) Pub. No.: US 2014/0379266 A1
(43) Pub. Date: Dec. 25, 2014

(54) PROCESSING SURVEY DATA CONTAINING GHOST DATA

(71) Applicant: WESTERNGECO L.L.C., Houston, TX (US)

(72) Inventors: KUN JIAO, KATY, TX (US); DONG SUN, KATY, TX (US); WEI HUANG, KATY, TX (US); XIN CHENG, KATY, TX (US); DENES VIGH, HOUSTON, TX (US)

(21) Appl. No.: 14/303,455

(22) Filed: Jun. 12, 2014

Related U.S. Application Data
(60) Provisional application No. 61/839,284, filed on Jun. 25, 2013.

(51) Int. Cl. G01V 1/36

(52) U.S. Cl. CPC G01V 1/362
USPC 702/17

(57) ABSTRACT

Input survey data containing ghost data is processed, the ghost data containing data caused by a reflection from an interface, and the processing including performing full wave propagation. An output is produced in response to the processing.

### CROSS REFERENCE TO RELATED APPLICATION

This application claims the benefit of U.S. Provisional Patent Application Ser. No. 61/839,284 filed Jun. 25, 2013, which is incorporated herein by reference in its entirety.

### BACKGROUND

Survey data can be collected and processed to produce a representation (e.g., an image, a model, etc.) of a subsurface structure. In some implementations, survey data includes seismic data collected using seismic survey equipment. The seismic survey equipment includes one or more seismic sources that are activated to produce seismic wavefields propagated into the subsurface structure. A part of the seismic wavefields is reflected from the subsurface structure and detected by seismic receivers that are part of the seismic survey equipment.

Seismic surveying can be performed in a marine environment. An issue associated with marine seismic surveying is the presence of ghost data. Ghost data refers to data in measurement data (measured seismic data) resulting from reflections from an air-water interface of the marine environment. A seismic wavefield generated by a seismic source is propagated generally downwardly into the subsurface structure. A reflected seismic wavefield (that is in response to the seismic wavefield propagated by the seismic source) propagates generally upwardly toward an arrangement of seismic receivers. In the marine environment, where receivers are generally positioned at a depth (or multiple depths) beneath the water surface, the seismic wavefield reflected from the subsurface structure continues to propagate upward past the receivers towards the air-water interface, where the seismic wavefield is reflected back downwardly.

This reflected, generally downwardly traveling seismic wavefield from the air-water interface is detected by the seismic receivers as ghost data, which appears in measurement data collected by the seismic receivers. The presence of ghost data can result in reduced accuracy when generating a representation of the subsurface structure based on the measurement data.

### SUMMARY

Input survey data containing ghost data is processed, the ghost data containing data caused by a reflection from an interface, and the processing including performing full wave propagation. An output is produced in response to the processing.

Other or additional features will become apparent from the following description, from the drawings, and from the claims.

### BRIEF DESCRIPTION OF THE DRAWINGS

Some implementations are described with respect to the following figures.

FIG. 1 is a schematic diagram of a marine survey arrangement according to some examples.

FIGS. 2-8 are flow diagrams of workflows according to various implementations.

FIG. 9 is a block diagram of a computing system according to some implementations.

### DETAILED DESCRIPTION

Reference is made in this disclosure to various implementations, examples of which are illustrated in the accompanying drawings and figures. In the following detailed description, numerous specific details are set forth in order to provide a thorough understanding of some embodiments. However, it will be apparent to one of ordinary skill in the art that other embodiments may be practiced without these specific details.

The terminology used in the description is for the purpose of describing example embodiments. As used in the description and the appended claims, the singular forms “a,” “an” and “the” are intended to include the plural forms as well, unless the context clearly indicates otherwise. It will be further understood that the terms “includes,” “including,” “comprises” and/or “comprising,” when used in this application, specify the presence of stated features, integers, tasks, operations, elements, and/or components, but do not preclude the presence or addition of one or more other features, integers, tasks, operations, elements, components, and/or groups thereof.

In the ensuing discussion, reference is made to performing seismic data processing according to some implementations in a marine survey environment. Note, however, that techniques or mechanisms according to some implementations can also be applied in land-based survey environments or wellbore-based survey environments in which ghost data can appear in measured survey data, such as measured by one or more survey receivers.

Although reference is made to subsurface structures or formations in the disclosure, it is contemplated that techniques or mechanisms according to some implementations can be applied to other types of target structures, such as human tissue, mechanical structures, plant tissue, animal tissue, solid volumes, substantially solid volumes, volumes of liquid, volumes of gas, volumes of plasma, and volumes of space near and/or outside the atmosphere of a planet, asteroid, comet, moon, or other body, and so forth.

Seismic data collected by seismic receivers can be processed to generate a representation of a target structure, such as a subsurface structure or other type of structure. The representation of the subsurface structure can include an image of the subsurface structure, a model of the subsurface structure, or another type of representation of the subsurface structure. The representation of the subsurface structure can include properties of elements in the subsurface structure, such as properties of a reservoir that can contain hydrocarbons or other fluids.

More generally, although reference is made to seismic data collected by seismic receivers, it is noted that techniques or mechanisms according to some implementations can be applied to other measured survey data collected by other survey receivers. Generally, survey receivers can acquire survey data, which can include seismic wavefields, acoustic signals, or other signals.

Ghost data due to reflections from an air-water interface in a marine survey environment can result in accuracies when generating a representation of the subsurface structure based on measured seismic data. When a ghost reflection (a wavefield reflected form the air-water interface) reaches seismic receivers, the ghost reflection (downgoing wavefield) can interfere with the subsurface reflected wavefield (upgoing wavefield). A downgoing wavefield can refer to a wavefield having at least one component that travels downwardly. An upgoing wavefield has at least one component that travels upwardly.

The ghost reflection can generate notches in the spectrum of the measured seismic data, reducing the useable bandwidth of the measured seismic data and hence its resolution of. The notches created by the ghost reflection can compromise the recorded seismic waveform.

In other examples, a ghost reflection can reflect from a different reflection interface (other than an air-water interface). Ghost data can result from a reflection from an interface that produces an inaccuracy in measured survey data that includes wavefields reflected from a target structure, where the target structure is separate and distinct from the reflection interface.

Traditionally, pre-processing is applied on measured seismic data to first remove the ghost effect before a further processing workflow is applied. Examples of processing workflows that can be applied on the pre-processed seismic data (in which ghost data has been removed) can include one or some combination of the following, as examples: a migration process that produces an image of a subsurface structure, an inversion process that produces a model of a subsurface structure, and a source wavelet estimation process to estimate a source wavelet produced by a survey source, such as a seismic source (e.g., an airgun, a vibrator, an explosive, etc.).

An example of a migration process is a Reverse Time Migration (RTM) process. An example of an inversion process is a Full Waveform Inversion (FWI) process. An example of a source wavelet estimation process is a Source Wavelet Inversion (SWI) process. Traditionally, the foregoing processing workflows (RTM, FWI, and/or SWI) are applied on ghost-free data (pre-processed seismic data in which ghost data attenuation or removal has been performed). However, pre-processing to remove the ghost effect can be relatively complex and processing intensive.

In accordance with some implementations, processing of seismic data, including processing using one or more of RTM, FWI, SWI, and so forth, can be performed on input seismic data that contains ghost data. Seismic data (or more generally, survey data) containing ghost data can refer to survey data in which contributions due to reflected wavefields from an air-water interface (or other corresponding interface) are present. Using techniques or mechanisms according to some implementations, pre-processing to remove a ghost effect does not have to be first performed before application of a processing workflow such as one or more of RTM, FWI, and SWI (or more generally, one or more of a migration process, an inversion process, or a source wavelet estimation process).

The processing according to some implementations, which is applied on input survey data that contains ghost data, is able to simulate a signal that contributes to the ghost effect. Based on such simulated signal, a final output of the processing can remove the ghost effect.

Reverse Time Migration (RTM) is a seismic imaging technique. RTM is a two-way wave-equation based migration technique, that utilizes full wave propagation for producing more accurate subsurface images at areas with structural and velocity complexities, such as sedimentary areas with steep dip salt inclusions or other elements. A migration process is a process by which seismic events are geometrically re-located in either space or time to the location the event occurred in the subsurface. RTM propagates events both downwardly and upwardly through an earth model, and is able to handle turning waves and other complex propagation paths. Full wave propagation refers to a technique for propagating wavefields using a two-way wave equation, such that wavefields can be propagated (such as by using an earth model) both upwardly and downwardly.

Full Waveform Inversion (FWI) is a full wave propagation based inversion technique. FWI iteratively updates velocity fields to reduce a misfit between the measured seismic data and simulated waveforms (simulated using a current velocity model). This iterative process iteratively refines the velocity model until a stopping criterion is satisfied. FWI uses full wave equation modeling at each iteration. FWI also uses a two-way wave equation for propagating wavefields upwardly and downwardly. The velocity model that is output by an FWI can be used in further processing, such as a migration process (e.g., RTM).

SWI is used for estimating a source wavelet, which is a time series and can be used to produce a wavefield. An accurate estimation of the source wavelet can result in more accurate processing of measured seismic data, where the processing can include FWI and/or RTM. Without an accurate estimation of a source wavelet, FWI or RTM may lead to incorrect inverted models or migration images, respectively, of a subsurface structure.

Each of the RTM, FWI, and SWI processes employs full wave propagation or simulation.

By avoiding the performance of pre-processing of measured seismic data to remove ghost effects, the overall seismic data processing workflow can be performed more quickly and efficiently. Additionally, since pre-processing to remove ghost effects is skipped, the seismic data processing workflow can be applied directly to measured seismic data, rather than pre-processed seismic data. Processing workflows such as FWI, RTM, or SWI may benefit from using high fidelity fully recorded seismic wavefields (which can be provided due to skipping of the pre-processing stage).

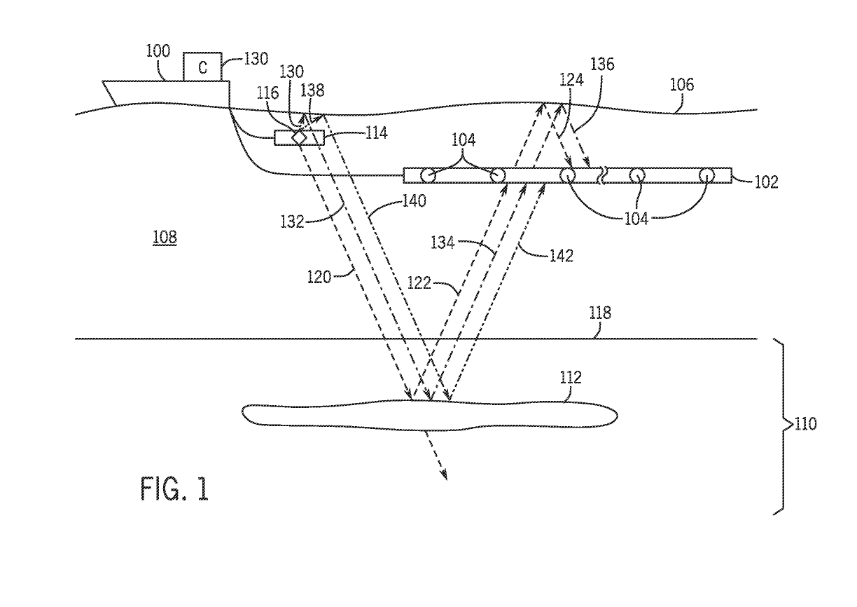

FIG. 1 illustrates an example marine survey arrangement that includes a marine vessel 100 for towing a streamer 102 that includes seismic receivers 104. In addition, the marine vessel 100 (or a different marine vessel) can tow a seismic source assembly 114, which has at least one seismic source 116. Although the streamer 102 is shown as being generally horizontal in orientation, it is noted that in other examples, the streamer 102 can be slanted with respect to a water surface 106, such that seismic receivers 104 along the length of the streamer 102 are at different depths.

The marine vessel 100 tows the streamer 102 and seismic source assembly 114 through a body of water 108 above a bottom surface 118 (e.g., seafloor). The streamer 102 can be towed in generally straight line paths. In another example, the streamer 102 can be towed along coil paths or spiral paths.

A subsurface structure 110 is located below the bottom surface 118, and the subsurface structure 110 includes at least one subsurface element 112 of interest. Examples of the subsurface element 112 can include a hydrocarbon-bearing reservoir, a freshwater aquifer, a gas injection zone, or other subsurface element of interest.

FIG. 1 further depicts an arrow 120 that represents a seismic wavefield generated by the seismic source 116 and traveling generally downwardly into the subsurface structure 110. A portion of the seismic wavefield 120 is reflected from the subsurface structure 110, and travels generally upwardly (as indicated by arrow 122) toward the streamer 102. The upgoing seismic wavefield (122) is detected by the seismic receivers 104 of the streamer 102.

The upgoing seismic wavefield (122) continues to travel upwardly until the wavefield reaches the air-water interface (106), where the seismic wavefield is reflected generally downwardly (as indicated by arrow 124). The reflected downgoing seismic wavefield (124) is also detected at the seismic receivers 104, which causes ghost data to appear in the measurement data collected by the seismic receivers 104. This ghost data is considered receiver ghost data. The reflected downgoing wavefield interacts with the upgoing wavefield, which causes constructive and destructive interference that results in the ghost data. This interference is detrimental to the seismic data since it causes amplitude and phase distortions and can result in total removal of frequencies near the so-called ghost notch frequency.

FIG. 1 also shows an upgoing wavefield (138) that is reflected from the air-water interface (106). The reflected wavefield (140) propagates generally downwardly into the subsurface structure 110. A portion of the seismic wavefield (140) is reflected from the subsurface structure 110, and travels generally upwardly (as indicated by arrow 142) toward the streamer 102. The upgoing seismic wavefield (142) is detected by the seismic receivers 104 of the streamer 102. This upgoing seismic wavefield (142) causes a source ghost data to be measured by the seismic receivers 104.

FIG. 1 additionally shows an upgoing wavefield (130) that is reflected from the air-water interface (106). The reflected wavefield (132) propagates generally downwardly into the subsurface structure 110. A portion of the seismic wavefield (132) is reflected from the subsurface structure 110, and travels generally upwardly (as indicated by arrow 134) toward the streamer 102.

The upgoing seismic wavefield (134) continues to travel upwardly until the wavefield reaches the air-water interface (106), where the seismic wavefield is reflected generally downwardly (as indicated by arrow 136). The reflected downgoing seismic wavefield (136) and the upgoing wavefield (134) are also detected at the seismic receivers 104, which causes source and receiver ghost data to appear in the measurement data collected by the seismic receivers 104.

For simplicity, FIG. 1 depicts an example that includes a few instances of a source downgoing wavefield 120, a reflected upgoing wavefield 122, and a reflected downgoing wavefield 124. In an actual survey environment, there can be many instances of the various downgoing and upgoing wavefields. Also, in other examples, the survey arrangement can include more than one seismic source 116, in which case there can be additional instances of the various wavefields.

Generally, an upgoing wavefield refers to a wavefield that travels in a direction that has at least one directional component that is in the vertical up direction. Similarly, a downgoing wavefield refers to a wavefield that travels in a direction that has at least one directional component that is in the vertical down direction.

FIG. 1 further depicts a control system 130 deployed at the marine vessel 100. The control system 130 can be used to control activation of the seismic source assembly 114. The control system 130 can also receive measurement data collected by the seismic receivers 104. In some examples, the control system 130 is able to process the collected measurement data, such as to develop an image, a model, or other representation of the subsurface structure 110. In other examples, the collected measurement data from the seismic receivers 104 can be communicated to a remote system for further processing. The processing performed by the control system 130 or by another system can include processing of measured seismic data that contains ghost data, in accordance with some implementations.

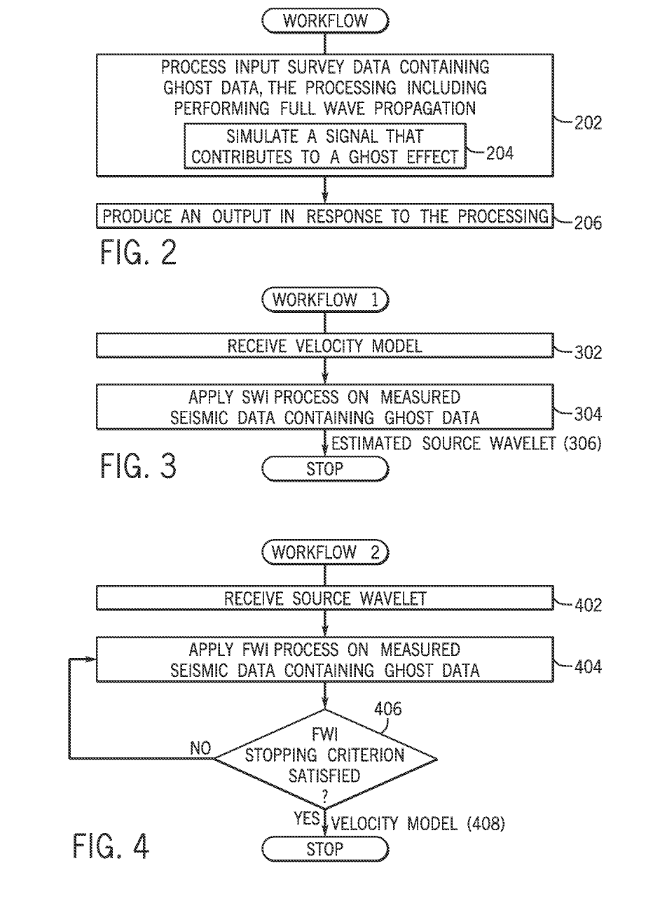

FIG. 2 is a flow diagram of a workflow that can be performed by the control system 130, according to some implementations. The workflow can process (at 202) input survey data (e.g., seismic data measured by the seismic receivers 104) that contains ghost data. The processing that is performed includes performing a full wave propagation, which is applied on the input survey data. The processing (at 202) also includes simulating (at 204) a signal that contributes to a ghost effect, where the ghost effect results from wavefield reflection from an air-water interface (e.g., 106 in FIG. 1).

In some examples, the processing performed at 202 can include one or more of an RTM process, an FWI process, and an SWI process. If the processing performed at 202 includes an SWI process, then a source wavelet estimated using the SWI process can be provided for use in another process, such as an RTM process or an FWI process, according to some examples.

The control system 130 next produces (at 206) an output in response to the processing (at 202). The output that is produced can include one or more of an image of the subterranean structure, a model of the subterranean structure, and an estimated source wavelet. Since a signal that contributes to a ghost effect is simulated as part of the processing performed (at 202), the simulated ghost effect can be removed from the output produced (at 206).

The following provides further details regarding workflows according to some implementations.

### FWI Processing

FWI processing is based on iteratively building a model (e.g., a velocity model) of a subsurface structure by minimizing a misfit function expressed in Eq. 1 below, where the misfit function measures a difference between measured seismic data and simulated seismic data (seismic data simulated using a current version of the velocity model):

$${min}_{m ∈ M} 𝒥 := \frac{1}{2} {\sum }_{s = 1}^{Ns} {‖ {F}_{gf} [ m ] ( {x}_{r} , t ) - {d}_{{0}_{gf}} ( {x}_{r} , t ; s ) ‖}^{2} , \qquad ( Eq . 1 )$$

where [symbol] denotes the misfit function, model M represents a set of one or more candidate velocity models, data dₒ₀_{_{gf}} represents the input ghost-free measured seismic data, and F_{gf}[m] represents a ghost-free forward map. The nonlinear inverse problem of Eq. 1 can be solved by an iterative non-linear conjugate gradient approach with a line search minimization strategy, and the gradient can be computed with the following equation.

$${∇}_{m} 𝒥 = {\sum }_{s = 1}^{{N}_{s}} {DF}_{gf} [ m ] * ( {F}_{gf} [ m ] ( {x}_{r} , t ) - {d}_{{0}_{gf}} ( {x}_{r} , t ; s ) ) , \qquad ( Eq . 2 )$$

where DF_{gf}[m]* stands for the adjoint operator of DF_{gf}[m], the first derivative map of F_{gf}[m]. The first derivative map, DF_{gf}[m], includes a ghost-free backward propagation and an application of an imaging condition on the backwardly propagated wavefield and the forwardly propagated wavefield generated by F_{gf}[m].

The foregoing FWI processing depends upon use of ghost-free input seismic data, represented as d₀_{_{gf}}, which has to be first pre-processed. Also, the FWI processing uses the ghost-free forward map, F_{gf}[m], which is a forward map defined using a ghost-free simulator. The ghost-free simulator generates ghost-free data for a candidate subsurface model m by numerically solving a system of wave equations with an absorbing boundary condition through a finite difference technique. An absorbing boundary condition assumes a boundary (e.g., boundary corresponding to the air-water interface) that does not reflect a wavefield that can lead to a ghost effect.

In accordance with some implementations, the FWI process is modified to directly handle input measured seismic data that contains ghost data, by changing the misfit function [symbol] to the following equation:

$${min}_{m ∈ M} 𝒥 := \frac{1}{2} {\sum }_{s = 1}^{Ns} {‖ {C}_{sr} {F}_{g} [ m ] ( {x}_{r} , t ) - {C}_{sr} {d}_{{0}_{g}} ( {x}_{r} , t ; s ) ‖}^{2} , \qquad ( Eq . 3 )$$

where data d₀_{_{g}} represents measured seismic data that contains ghost data, and F_{g}[m] represents a forward map with a ghost simulator, which produces calculated data with a source/receiver ghost effect by solving a wave equation with finite difference algorithm on a candidate subsurface model m. In Eq. 3, Cₛᵣ denotes a compensation operator for the source/receiver ghost effect. The forward map, F_{g}[m], employs a ghost simulator that is able to simulate a signal that contributes to the ghost effect, where this simulated signal is reflected from the air-water interface (e.g., 106 in FIG. 1). F_{g}[m] generates data containing ghost data (including wavefields reflected from the air-water interface) for a candidate subsurface model m by numerically solving a system of wave equations with an absorbing boundary condition, and with ghost sources and receivers through a finite difference technique.

The ghost simulator can be implemented with a wave equation solver (to solve a system of wave equations for simulating a signal corresponding to ghost data) that uses a finite difference and finite element method, using either (1) dipole injection and extraction, or (2) a simple boundary condition such as free surface boundary condition.

The compensation operator Cₛᵣ can be implemented in several ways, such as with a simple spectrum compensation pre-filter that is applied to input data, or a more complicated deconvolution filter that is applied in imaging condition tasks, to compensate for the source and receiver ghost effect caused by the air-water interface.

The gradient for the modified FWI is changed to

$${∇}_{m} 𝒥 = {\sum }_{s = 1}^{{N}_{s}} {{DF}_{g} [ m ]}^{*} {C}_{sr}^{*} ( {C}_{sr} {F}_{g} [ m ] ( {x}_{r} , t ) - {C}_{sr} {d}_{{0}_{g}} ( {x}_{r} , t ; s ) ) , \qquad ( Eq . 4 )$$

where Cₛᵣ* represents the adjoint operator of Cₛᵣ, DF_{g}[m]* denotes the adjoint of the first derivative map, DF_{g}[m], of F_{g}[m] with respect to m. The first derivative map, DF_{g}[m], includes a backward propagation using the ghost simulator and an application of an imaging condition on the backwardly propagated wavefield and the forwardly propagated wavefield generated by F_{g}[m].

### RTM Processing

RTM is a two-way wave equation based imaging technique that propagates a source wavefield forward and the ghost-free input data backwards in time using the two-way wave equation. RTM also applies an imaging condition on both the source wavefield and the backwardly-propagated wavefield to form a seismic image I(x) as set forth in Eq. 5 below.

A technique according to Eq. 5 propagates source wavefields and recorded wavefields in any arbitrary direction with respect to time.

$$I ( x ) = {\sum }_{s = 1}^{{N}_{s}} {{DF}_{gf} [ m ]}^{*} {d}_{{0}_{gf}} ( {x}_{r} , t ; s ) , \qquad ( Eq . 5 )$$

In Eq. 5, data d₀_{_{gf}} represents the input ghost-free measured seismic data, and DF_{gf}[m] represents the first derivative map of F_{gf}[m] with respect to m, similar to the same operators used in the FWI process discussed further above in connection with Eqs. 1 and 2.

In Eq. 5, pre-processing is performed to produce the ghost-free input seismic data d₀_{_{gf}}.

In accordance with some implementations, an RTM process can be modified to handle input seismic data containing ghost data, such as according to Eq. 6 below.

$$I ( x ) = {\sum }_{s = 1}^{{N}_{s}} {{DF}_{g} [ m ]}^{*} {C}_{sr}^{*} ( {C}_{sr} {d}_{{0}_{g}} ( {x}_{r} , t ; s ) ) , \qquad ( Eq . 6 )$$

In Eq. 6, data d₀_{_{g}} represents measured seismic data that contains ghost data, and DF_{g}[m]* represents the adjoint of the first derivative map, DF_{g}[m], of F_{g}[m], which is the forward map that uses a ghost simulator similar to that used in the modified FWI process discussed further above.

This modified RTM process uses the ghost simulator to perform forward propagation of a source wavefield, backward propagation of input seismic data containing ghost data with a ghost simulator, and applying an imaging condition that accounts for a ghost effect. The source receiver ghost effect which is generated by the nearly perfect negative reflectivity air-water interface can distort the phase and amplitude spectrum of the acquired seismogram. Using the ghost simulator as part of the FWI and RTM processing with an inverted source wavelet can compensate for the phase spectrum distortion caused by the ghost effect. However, the amplitude spectrum loss caused by the ghost effect will be increased. As a result, amplitude spectrum compensation is applied for FWI and RTM processing that uses the ghost simulator. A spectrum shaping filter can be applied to the input data to account for the amplitude loss, or a more deconvolution type of imaging condition can be applied.

### SWI Processing

A small disturbance in a source wavelet (a wavefield produced by a seismic source) can lead to a relatively large discrepancy in results produced by an inversion process (e.g., FWI process) or a migration process (e.g., RTM process). Measured seismic data and simulated seismic data depend on both the source signature and model parameters, both of which are initially unknown. Accurate source wavelet estimation can depend on recovering accurate model parameters. By employing SWI together with FWI, both model parameters and the source wavelet propagation can be iteratively refined. In further examples, if the model parameters are built using another model building process, such that the model parameters are relatively accurate, SWI can be applied individually to estimate the source wavelet accurately.

In some implementations, the gradient of a misfit function related to both model parameters and the source wavelet can be reduced or removed once a solution to an inversion is computed. To achieve such a solution, updating a source wavelet and updating model parameters can be alternately performed in sequence. More specifically, a source wavelet can be estimated for a current model to reduce or remove a gradient of the misfit function related to the source wavelet. Next, the estimated source wavelet can be used to iteratively update a model. With the updated model, a further refinement of the source wavelet can be computed, followed again by using the further refined source wavelet to update the model. The foregoing iterative process can be repeated until a stopping criterion is satisfied.

An estimated source wavelet is a solution to a least-squares based filter estimation, such as:

w=(G*_{gf}[m]G_{gf}[m])⁻¹G*_{gf}[m]d₀_{_{gf}}, (Eq. 7)

where w is the estimated source wavelet, d₀_{_{gf}} represents ghost-free measured seismic data, G_{gf}[m] represents a convolution operator based on ghost-free impulse responses of a candidate model m extracted at receiver locations, which can be computed using finite difference simulation with a semi-spike source, and G*_{gf}[m] represents the adjoint operator of G_{gf}[m].

The SWI processing can be modified for application to measured seismic data containing ghost data by modifying Eq. 7 to become

w=(G*[m]C*ₛᵣCₛᵣG[m])⁻¹G*[m]C*ₛᵣCₛᵣd₀_{ₛ}, (Eq. 8)

where d₀_{_{g}} represents the measured seismic data containing ghost data, G[m] represents a convolution operator based on dipole impulse responses δ[m] of a current candidate model m extracted at receiver locations (i.e., for any data d, G[m]d:=δ[m]*d), Cₛᵣ represents for the source/receiver ghost effect compensation operator, G*[m] and C*ₛᵣ respectively represent the adjoint operators of G[m] and Cₛᵣ. Eq. 8 provides for an example of SWI processing to produce an estimated source wavelet, w, by solving a least-squares based filter estimation problem. In Eq. 8, G[m] is computed using a ghost simulator with a semi-spike source, where a semi-spike source refers to a seismic source that produces an impulse wavefield.

The ghost simulator used for G[m] can be the same as the ghost simulator used in the FWI and RTM processes.

FIG. 3 is a flow diagram of an example workflow (Workflow 1) according to some implementations. Workflow 1 assumes that velocity model of a subsurface structure is known (has been derived using some technique). Workflow 1 receives (at 302) the velocity model. Workflow 1 then applies (at 304) an SWI process (such as according to Eq. 8 above), using the received velocity model, on measured seismic data containing ghost data, to produce an estimated source wavelet (306).

FIG. 4 is a flow diagram of an example workflow (Workflow 2) according to further implementations. Workflow 2 assumes that a source wavelet is known (derived using some technique). Workflow 2 receives (at 402) the source wavelet. Next, Workflow 2 applies (at 404) an FWI process (such as according to Eqs. 3 and 4) on measured seismic data containing ghost data, to produce model parameters for a velocity model. The FWI process uses the received source wavelet. Workflow 2 determines (at 406) whether an FWI stopping criterion is satisfied. For example, a stopping criterion is satisfied if an error between measured seismic data and simulated seismic data (produced using a current velocity model) is less than a specified threshold. If the FWI stopping criterion is not satisfied, then the FWI process is applied (at 404) again, in an iterative process, until the FWI stopping criterion is satisfied.

Once the FWI stopping criterion is satisfied, the output of the FWI process is a velocity model (408).

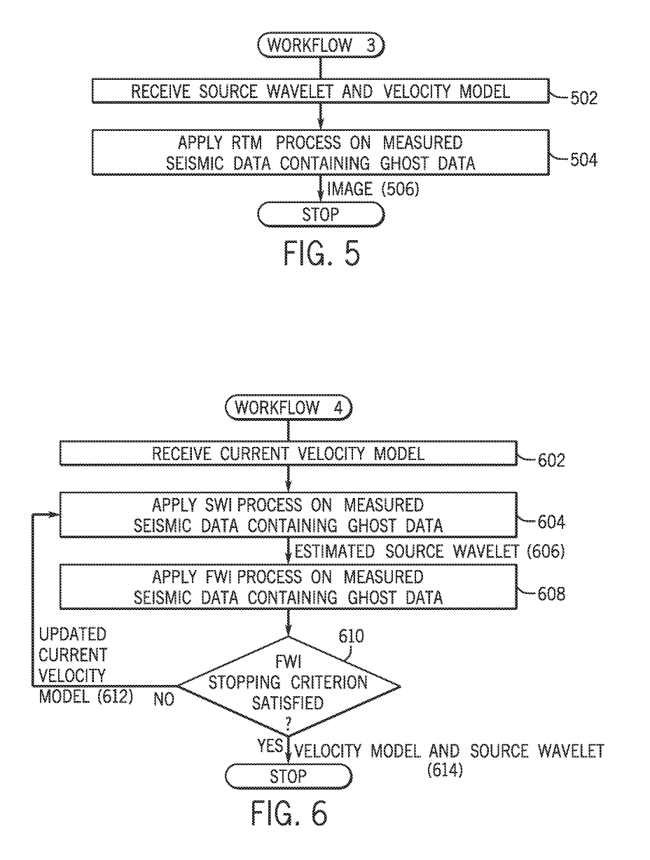

FIG. 5 is a flow diagram of an example workflow (Workflow 3) according to further implementations. Workflow 3 assumes that both a source wavelet and a velocity model are known (derived using some techniques). Workflow 3 receives (at 502) the source wavelet and the velocity model.

Workflow 3 then applies (at 504) an RTM process (such as according to Eq. 6 above) on measured seismic data containing ghost data. The RTM process uses the received source wavelet and the velocity model, for use in propagating wavefields for determining an image (506) of a subsurface structure.

FIG. 6 is a flow diagram of another example workflow (Workflow 4) according to further implementations. Workflow 4 receives (at 602) a current velocity model, which may not be accurate. Workflow 4 then applies (at 604) an SWI process (such as according to Eq. 8 above) on measured seismic data containing ghost data, with the current velocity model to produce the estimated source wavelet (606). At this point, if the current velocity model is not accurate, then the estimated source wavelet (606) may not be accurate.

Next, Workflow 4 applies (at 608) an FWI process (such as according to Eqs. 3 and 4) on measured seismic data containing ghost data, to produce updated model parameters for a velocity model. The FWI process uses the estimated source wavelet (606) output by the SWI process. Workflow 4 determines (at 610) whether an FWI stopping criterion is satisfied. If the FWI stopping criterion is not satisfied, then an updated current velocity model (612) is provided to task 604, which iterates the application of the SWI process (using the updated current velocity model) to produce an updated source wavelet, and then iterates the application (at 608) of the FWI process using the updated source wavelet, to produce a further updated velocity model.

The iterative process (including tasks 604, 608, and 610) is repeated to iteratively update the estimated source wavelet and the velocity model until the FWI stopping criterion is satisfied. Once the FWI stopping criterion is satisfied, the output of the FWI process is an output velocity model and an inverted/estimated source wavelet (614).

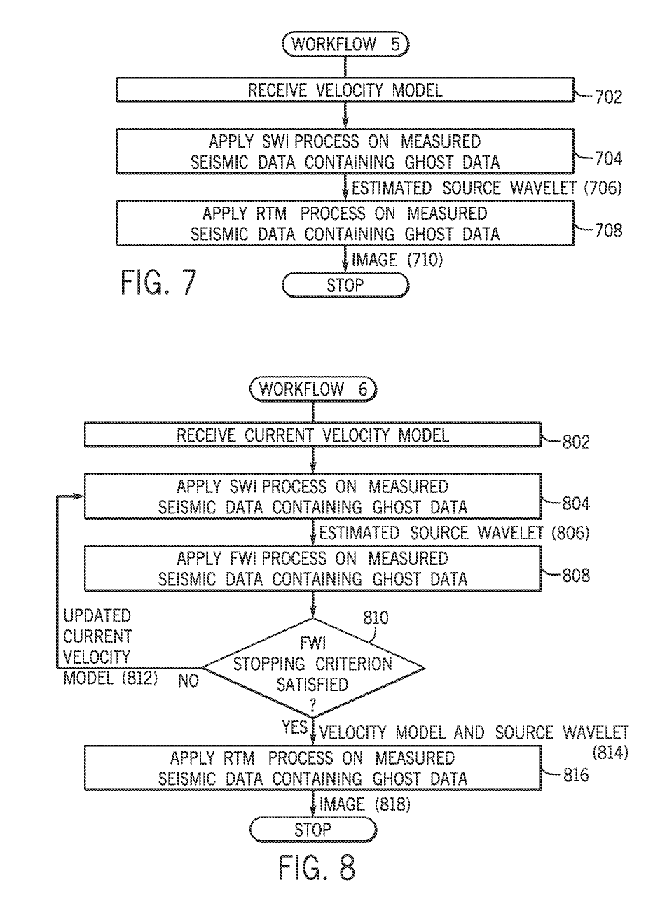

FIG. 7 is a flow diagram of another example workflow (Workflow 5) according to additional implementations. Workflow 5 receives (at 702) a velocity model, which has been derived using a separate process. Workflow 5 assumes that the velocity model is known. Workflow 5 then applies (at 704) an SWI process (such as according to Eq. 8 above) on measured seismic data containing ghost data, to produce an estimated source wavelet (706). The SWI process uses the received velocity model to produce the estimated source wavelet (706).

Next, Workflow 5 applies (at 708) an RTM process (such as according to Eq. 6 above) on measured seismic data containing ghost data. The RTM process uses the received velocity model and the estimated source wavelet (706) output by the SWI process, for use in propagating wavefields for determining an image (710) of a subsurface structure.

FIG. 8 is a flow diagram of another example workflow (Workflow 6), in which the source wavelet and the velocity model are initially unknown. Workflow 4 receives (at 802) a current velocity model, which may not be accurate. Workflow 6 then applies (at 804) an SWI process (such as according to Eq. 8 above) on measured seismic data containing ghost data, with the current velocity model to produce the estimated source wavelet (806). At this point, if the current velocity model is not accurate, then the estimated source wavelet (806) may not be accurate.

Next, Workflow 6 applies (at 808) an FWI process (such as according to Eqs. 3 and 4) on measured seismic data containing ghost data, to produce updated model parameters for a velocity model. The FWI process uses the estimated source wavelet (806) output by the SWI process. Workflow 6 determines (at 810) whether an FWI stopping criterion is satisfied. If the FWI stopping criterion is not satisfied, then an updated current velocity model (812) is provided to task 804, which iterates the application of the SWI process (using the updated current velocity model) to produce an updated source wavelet, and then iterates the application (at 808) of the FWI process using the updated source wavelet, to produce a further updated velocity model.

The iterative process (including tasks 804, 808, and 810) is repeated to iteratively update the estimated source wavelet and the velocity model until the FWI stopping criterion is satisfied. Once the FWI stopping criterion is satisfied, the output of the FWI process is an output velocity model and an estimated source wavelet (814).

Next, Workflow 6 applies (at 816) an RTM process (such as according to Eq. 6 above) on measured seismic data containing ghost data. The RTM process uses the output velocity model (814) and the estimated source wavelet (806) output by the SWI process, for use in propagating wavefields for determining an image (818) of a subsurface structure.

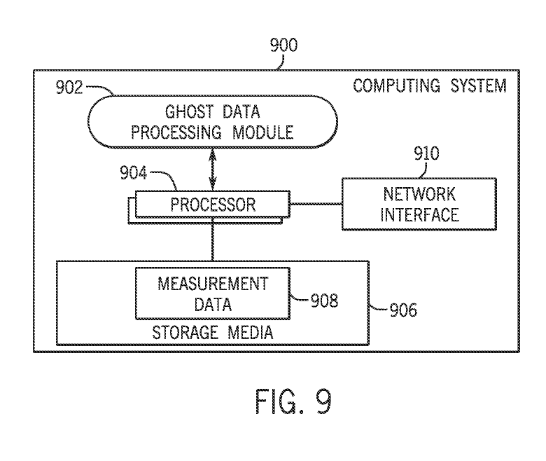

FIG. 9 illustrates an example computing system 900 (which can be used to implement the control system 130 of FIG. 1, for example, or another system) according to some implementations. The computing system 900 includes a ghost data processing module 902, which can be implemented as machine-readable instructions executable on one or multiple processors 904. The ghost data processing module 902 can perform various tasks discussed above, such as those depicted in FIGS. 2-8.

The computing system 900 can be implemented with a computer, or with a distributed arrangement of computers. A processor can include a microprocessor, microcontroller system, processor module or subsystem, programmable integrated circuit, programmable gate array, or another control or computing device.

The processor(s) 904 is (are) connected to a storage medium (or storage media) 906, which can store measurement data 908 collected by the survey receivers 104 depicted in FIG. 1. The computing system 900 also includes a network interface 910 to allow the computing system 900 to communicate with another system, such as with the streamer 102 to collect the measurement data, or with another system that communicates the measurement data to the computing system 900.

The storage medium (or storage media) 906 can be implemented as one or more non-transitory computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In general, according to some implementations, a method includes processing input survey data containing ghost data, the ghost data containing data caused by a reflection from an interface, and the processing including performing full wave propagation. An output is produced in response to the processing.

In general, according to further or other implementations, the processing further includes simulating a signal that contributes to a ghost effect.

In general, according to further or other implementations, the interface is an air-water interface.

In general, according to further or other implementations, producing the output comprises producing at least one selected from the group consisting of an image of a target structure, a model of the target structure, and a source wavelet.

In general, according to further or other implementations, the processing is part of a migration process that employs the full wave propagation.

In general, according to further or other implementations, the processing is part of an inversion process that employs the full wave propagation.

In general, according to further or other implementations, the processing is part of a source wavelet estimation process that that employs the full wave propagation and produces a source wavelet of a survey source.

In general, according to further or other implementations, the source wavelet is used in one or more of a reverse time migration process and a full waveform inversion process.

In general, according to further or other implementations, the processing includes iteratively performing, until a stopping criterion is satisfied, a source wavelet estimation process to estimate a source wavelet, and a full waveform inversion process to update a model of a target structure, where the estimated source wavelet is used by the full waveform inversion, and the updated model is used in a next iteration of the source wavelet estimation process.

In general, according to further or other implementations, the processing includes solving for a misfit function that employs the input survey data containing the ghost data, and an operator that includes a ghost simulator for simulating a ghost signal corresponding to the ghost data.

In general, according to further or other implementations, the processing includes using a compensation operator to compensate for a ghost effect corresponding to the ghost data.

In general, according to further or other implementations, the processing employs a model of a target structure for which the input survey data was acquired, and wherein the processing further includes updating the model.

In general, according to some implementations, a system includes at least one processor configured to: process input survey data containing ghost data, the input survey data acquired for by a survey acquisition system for a target structure, and the ghost data containing data caused by a reflection from an interface separate from the target structure, the processing including performing full wave propagation and using a ghost simulator to simulate a signal corresponding to the ghost data; and produce an output in response to the processing.

In general, according to further or other implementations, the output includes at least one selected from the group consisting of an image of the target structure, a model of the target structure, and a source wavelet.

In general, according to further or other implementations, the ghost simulator is to perform the simulating by solving a wave equation.

In general, according to further or other implementations, the processing includes at least one selected from the group consisting of a full waveform inversion process, a reverse time migration process, and a source wavelet inversion process.

In general, according to further or other implementations, the processing includes iteratively performing the full waveform inversion process and the source wavelet inversion process until a stopping criterion is satisfied.

In general, according to further or other implementations, the ghost data is produced by reflection from an air-water interface.

In general, according to some implementations, an article comprising at least one non-transitory machine-readable storage medium stores instructions that upon execution cause a system including a processor to: process input survey data acquired for a target structure and containing ghost data, the ghost data containing data caused by a reflection from an interface separate from the target structure, the processing including performing full wave propagation; and produce an output in response to the processing, the output selected from the group consisting of a model of the target structure, an image of the target structure, and an estimated source wavelet of a survey source.

In general, according to further or other implementations, the processing includes at least one selected from the group consisting of a full waveform inversion process, a reverse time migration process, and a source wavelet inversion process.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
processing input survey data containing ghost data, the ghost data containing data caused by a reflection from an interface, the processing including performing full wave propagation; and
producing an output in response to the processing.

2. The method of claim 1, wherein the processing further includes simulating a signal that contributes to a ghost effect.

3. The method of claim 1, wherein the interface is an air-water interface.

4. The method of claim 1, wherein producing the output comprises producing at least one selected from the group consisting of an image of a target structure, a model of the target structure, and a source wavelet.

5. The method of claim 1, wherein the processing is part of a migration process that employs the full wave propagation.

6. The method of claim 1, wherein the processing is part of an inversion process that employs the full wave propagation.

7. The method of claim 1, wherein the processing is part of a source wavelet estimation process that that employs the full wave propagation and produces a source wavelet of a survey source.

8. The method of claim 7, further comprising using the source wavelet in one or more of a reverse time migration process and a full waveform inversion process.

9. The method of claim 1, wherein the processing includes iteratively performing, until a stopping criterion is satisfied, a source wavelet estimation process to estimate a source wavelet, and a full waveform inversion process to update a model of a target structure, wherein the estimated source wavelet is used by the full waveform inversion, and the updated model is used in a next iteration of the source wavelet estimation process.

10. The method of claim 1, wherein the processing includes solving for a misfit function that employs the input survey data containing the ghost data, and an operator that includes a ghost simulator for simulating a ghost signal corresponding to the ghost data.

11. The method of claim 1, wherein the processing includes using a compensation operator to compensate for a ghost effect corresponding to the ghost data.

12. The method of claim 1, wherein the processing employs a model of a target structure for which the input survey data was acquired, and wherein the processing further includes updating the model.

13. A system comprising:
at least one processor configured to:
process input survey data containing ghost data, the input survey data acquired for by a survey acquisition system for a target structure, and the ghost data containing data caused by a reflection from an interface separate from the target structure, the processing including performing full wave propagation and using a ghost simulator to simulate a signal corresponding to the ghost data; and
produce an output in response to the processing.

14. The system of claim 13, wherein the output includes at least one selected from the group consisting of an image of the target structure, a model of the target structure, and a source wavelet.

15. The system of claim 13, wherein the ghost simulator is to perform the simulating by solving a wave equation.

16. The system of claim 13, wherein the processing includes at least one selected from the group consisting of a full waveform inversion process, a reverse time migration process, and a source wavelet inversion process.

17. The system of claim 16, wherein the processing includes iteratively performing the full waveform inversion process and the source wavelet inversion process until a stopping criterion is satisfied.

18. The system of claim 13, wherein the ghost data is produced by reflection from an air-water interface.

19. An article comprising at least one non-transitory machine-readable storage medium storing instructions that upon execution cause a system including a processor to:
process input survey data acquired for a target structure and containing ghost data, the ghost data containing data caused by a reflection from an interface separate from the target structure, the processing including performing full wave propagation; and
produce an output in response to the processing, the output selected from the group consisting of a model of the target structure, an image of the target structure, and an estimated source wavelet of a survey source.

20. The article of claim 19, wherein the processing includes at least one selected from the group consisting of a full waveform inversion process, a reverse time migration process, and a source wavelet inversion process.
